(19) United States
(12) Patent Application Publication
(10) Pub. No.: US 2024/0068382 A1
(43) Pub. Date: Feb. 29, 2024

(54) ROTARY MACHINE AND REFRIGERATION DEVICE USING SAME

(71) Applicant: Panasonic Intellectual Property Management Co., Ltd., Osaka-shi, Osaka (JP)

(72) Inventors: Hidetoshi TAGUCHI, Osaka (JP); Ko INAGAKI, Shiga (JP); Masaya HONMA, Hyogo (JP); Takumi HIKICHI, Osaka (JP)

(21) Appl. No.: 18/261,424

(22) PCT Filed: Jan. 14, 2022
(86) PCT No.: PCT/JP2022/001210

§ 371 Date: Jul. 13, 2023

(30) Foreign Application Priority Data
Jan. 15, 2021 (JP) 2021-005351

(51) Int. Cl. F01D 25/16; F01D 25/14; F04D 17/10; F04D 25/08

(52) U.S. Cl. CPC F01D 25/16; F01D 25/14; F04D 17/10; F04D 25/082

(57) ABSTRACT

A rotary machine 100 includes a bearing 10, a rotary shaft 20, a turbine wheel 30, a turbine nozzle 31, and a first cavity 40. The bearing 10 has a first end face 10a and a second end face 10b each positioned in the axial direction of the rotary shaft 20. The distance from the first end face 10a to the turbine wheel 30 is shorter than the distance from the second end face 10b to the turbine wheel 30. The first cavity 40 is positioned, in the axial direction of the rotary shaft 20, between a back surface 31b of the turbine nozzle 31 and the second end face 10b of the bearing 10 or between the back surface 31b of the turbine nozzle 31 and a space 11 that the second end face 10b of the bearing 10 faces. The first cavity 40 is present in the zone overlapping with the turbine nozzle 31 in a radial direction of the rotary shaft 20.

### TECHNICAL FIELD

The present disclosure relates to a rotary machine and a refrigeration device using the same.

### BACKGROUND ART

Patent Literature 1 discloses a cryogenic rotary machine. This cryogenic rotary machine includes: an impeller that imparts a kinetic energy to a cryogenic refrigerant that is a working fluid; a drive device that rotationally drives the impeller; a rotary shaft that transfers a rotational force of the drive device to the impeller; and a journal bearing that supports the rotary shaft. A heat-insulating material is disposed between the impeller and the journal bearing.

### CITATION LIST

### Patent Literature

Patent Literature 1: JP 2011-252442 A

### SUMMARY OF INVENTION

### Technical Problem

In a rotary machine, heat may be transferred from a heat generation source such as a bearing to a working fluid. When excessively receiving heat, the working fluid unintentionally increases in temperature.

The present disclosure provides a technique for reducing heat to be transferred from a heat generation source such as a bearing to a working fluid.

### Solution to Problem

A rotary machine of the present disclosure includes:
a rotary shaft;
a turbine wheel attached to the rotary shaft;
a turbine nozzle disposed around the turbine wheel;
a bearing supporting the rotary shaft, and having a first end face and a second end face each positioned in an axial direction of the rotary shaft, where a distance from the first end face to the turbine wheel is shorter than a distance from the second end face to the turbine wheel; and
a first cavity positioned, in the axial direction of the rotary shaft, between a back surface of the turbine nozzle and the second end face of the bearing or between the back surface of the turbine nozzle and a space that the second end face of the bearing faces, the first cavity being present in a zone overlapping with the turbine nozzle in a radial direction of the rotary shaft.

### Advantageous Effects of Invention

According to the technique of the present disclosure, it is possible to reduce heat to be transferred from a heat generation source such as a bearing to a working fluid through a turbine nozzle.

### BRIEF DESCRIPTION OF DRAWINGS

FIG. 1 is a cross-sectional view of a rotary machine according to Embodiment 1.

FIG. 2 is a cross-sectional view of a rotary machine according to Embodiment 2.

FIG. 3 is a cross-sectional view of a rotary machine according to Embodiment 3.

FIG. 4 is a cross-sectional view of a rotary machine according to Embodiment 4.

FIG. 5 is a cross-sectional view of a rotary machine according to Embodiment 5.

FIG. 6 is a configuration diagram of a refrigeration device according to Embodiment 6.

### DESCRIPTION OF EMBODIMENTS

(Findings Etc. On which the Present Disclosure is Based)

At the time when the inventors came to conceive of the present disclosure, as one problem of rotary machines that handle a cryogenic working fluid for −190° C. to −260° C. such as neon and helium, a large temperature difference between the working fluid and the machine part has been known. A large temperature difference between the working fluid and the machine part extremely increases the amount of heat flowing into the working fluid, changing the state quantity of the working fluid. Patent Literature 1 has proposed a structure for coping with this problem.

One of means for suppressing the heat transfer from a heat generation source such as a bearing to a fluid element such as a turbine wheel is to increase the length of a rotary shaft for heat insulation. However, lengthening the rotary shaft changes the dynamic characteristics of the rotary shaft to impair the rotational stability, and thus makes it difficult to operate the rotary machine in a high rotational speed range. The inventors found this problem and have come to constitute the subject matter of the present disclosure in order to solve this problem.

In view of this, the present disclosure provides a technique for reducing heat to be transferred from a heat generation source such as a bearing to a working fluid.

Embodiments will be described below in detail with reference to the drawings. However, more detailed description than necessary may be omitted. For example, detailed description of a well-known matter or overlapping description of substantially the same structure may be omitted. This is to prevent the following description from being unnecessarily redundant and facilitate the understanding by those skilled in the art.

The accompanying drawings and the following description are provided for those skilled in the art to fully understand the present disclosure, and are not intended thereby to limit the subject matter recited in the claims.

### Embodiment 1

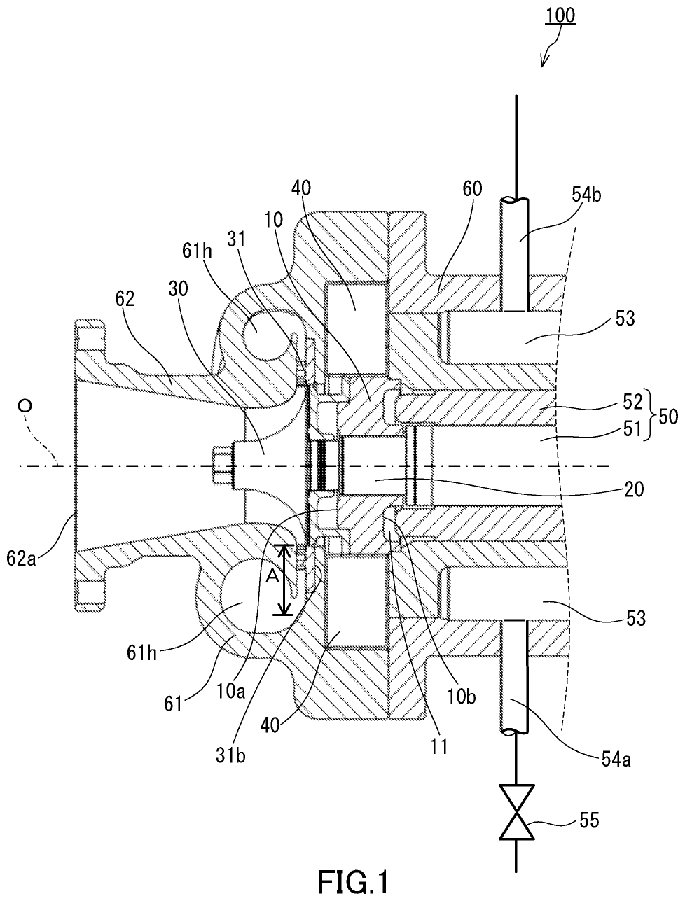

Embodiment 1 will be described below with reference to FIG. 1.

[1-1. Configuration]

FIG. 1 is a cross-sectional view of a rotary machine according to Embodiment 1. A rotary machine 100 includes a bearing 10, a rotary shaft 20, a turbine wheel 30, a turbine nozzle 31, and a first cavity 40. In the present embodiment, the rotary machine 100 is an expander. Specifically, the rotary machine 100 is a radial turbine.

The bearing 10 supports the rotary shaft 20. The bearing 10 has a first end face 10a and a second end face 10b each positioned in the axial direction of the rotary shaft 20. The distance from the first end face 10a to the turbine wheel 30 is shorter than the distance from the second end face 10b to the turbine wheel 30. In the present embodiment, the bearing 10 is a plain bearing. The working fluid for the rotary machine 100 is used as the lubricant for the bearing 10. The bearing 10 may be a magnetic bearing.

The turbine wheel 30 is a fluid element attached to one end portion of the rotary shaft 20. The turbine wheel 30 rotates together with the rotary shaft 20. Work is extracted from the working fluid by the turbine wheel 30.

The turbine nozzle 31 serves to direct the working fluid toward the turbine wheel 30. The turbine nozzle 31 has an annular shape and is disposed around the turbine wheel 30.

The first cavity 40 is positioned, in the axial direction of the rotary shaft 20, between a back surface 31b of the turbine nozzle 31 and the second end face 10b of the bearing 10 or between the back surface 31b of the turbine nozzle 31 and a space 11 that the second end face 10b of the bearing 10 faces. The first cavity 40 is present in the zone overlapping with the turbine nozzle 31 in the radial direction of the rotary shaft 20. In other words, the first cavity 40 is present in the zone overlapping with the turbine nozzle 31 as viewed along the axial direction of the rotary shaft 20. The first cavity 40 can generate thermal resistance between the turbine nozzle 31 and the heat generation source such as the bearing 10. Consequently, it is possible to suppress the heat transfer from the heat generation source such as the bearing 10 to the working fluid that is passing through the turbine nozzle 31. As a result, an unintended increase in temperature of the working fluid for the rotary machine 100 can be suppressed. The working fluid expands mainly in the turbine nozzle 31. While passing through the turbine nozzle 31, the working fluid is greatly decreased in temperature. Consequently, by suppressing the heat transfer to the turbine nozzle 31, it is possible to decrease the temperature of the working fluid to a lower temperature. The first cavity 40 may be a closed space or a space that communicates with an external atmosphere in which the rotary machine 100 is placed. In the case where the first cavity 40 is a closed space, the first cavity 40 may store a gas such as air or a liquid such as water, a brine, or an oil. The external atmosphere can be an air atmosphere.

The “axial direction” as used herein is the direction parallel to a central axis O of the rotary shaft 20. The “radial direction” as used herein is the direction orthogonal to the central axis O.

The position at which the distance to the central axis O of the rotary shaft 20 in the radial direction is 1.0 times the radius of the turbine wheel 30 is defined as a first position. The position at which the distance to the central axis O of the rotary shaft 20 in the radial direction is 1.8 times the radius of the turbine wheel 30 is defined as a second position. The position at which the distance to the central axis O of the rotary shaft 20 in the radial direction is 1.1 times the radius of the turbine wheel 30 is defined as a third position. The first cavity 40 is present in a zone A from the first position to the second position in the radial direction. The turbine nozzle 31 is usually disposed in the zone from the third position to the second position in the radial direction. Consequently, owing to the presence of the first cavity 40 in the zone A, it is possible to more effectively suppress the heat transfer from the heat generation source such as the bearing 10 to the working fluid that is passing through the turbine nozzle 31.

The first cavity 40 is, for example, an annular space surrounding the bearing 10 along the circumferential direction of the rotary shaft 20. The first cavity 40 may be a C-shaped space, or may be a plurality of separate portions so as to surround the bearing 10. According to such a structure, it is possible to more uniformly generate thermal resistance between the turbine nozzle 31 and the heat generation source such as the bearing 10.

The inner edge of the first cavity 40 in the radial direction is present, for example, in the zone overlapping with the turbine nozzle 31. In the present embodiment, the position of the inner edge of the first cavity 40 is defined by the position of the outer edge of the bearing 10. The outer edge of the first cavity 40 in the radial direction is present, for example, in the zone that is closer to the outside than the turbine nozzle 31 is. In the present embodiment, the first cavity 40 is present also in the zone that is closer to the outside than the turbine nozzle 31 is in the radial direction. According to such a structure, it is possible to more sufficiently suppress the heat transfer from the heat generation source such as the bearing 10 to the turbine nozzle 31.

The first cavity 40 may be present in the entirety of, or only a portion of, the zone A in the radial direction. That is, it is not essential that the first cavity 40 be present in the entirety of the zone A. The first cavity 40 may be additionally present in the zone overlapping with the turbine wheel 30 in the radial direction. Even according to such a structure, it is possible to generate thermal resistance between the turbine nozzle 31 and the heat generation source such as the bearing 10.

The first cavity 40 is present in the zone overlapping with the bearing 10 in the axial direction of the rotary shaft 20. According to such a structure, it is possible to more sufficiently suppress the heat transfer from the heat generation source such as the bearing 10 to the turbine nozzle 31.

The rotary machine 100 further includes a motor housing 60 and a turbine housing 61. The motor housing 60 and the turbine housing 61 are a first housing and a second housing, respectively. The bearing 10 is fixed to the motor housing 60 and is held by the motor housing 60. The turbine housing 61 surrounds the turbine wheel 30. The turbine housing 61 is fixed to the motor housing 60 so as to cover the bearing 10 and the turbine wheel 30. The turbine housing 61 has a volute 61h that is a flow path of the working fluid. The volute 61h communicates with the suction port (not shown) of the rotary machine 100. The stationary inner wall surface of the turbine housing 61 faces each of the turbine wheel 30 and the turbine nozzle 31. This defines flow paths of the working fluid. Specifically, a flow path of the working fluid is formed between the turbine housing 61 and the turbine nozzle 31. A flow path of the working fluid is formed between the turbine housing 61 and the turbine wheel 30.

The first cavity 40 is defined by the turbine housing 61. Specifically, the first cavity 40 is surrounded by the motor housing 60, the turbine housing 61, and the bearing 10. According to such a structure, it is possible to generate thermal resistance between the turbine nozzle 31 and the heat generation source such as the bearing 10 via the turbine housing 61. Furthermore, it is possible to shorten the startup time period of the rotary machine 100. The startup time period of the rotary machine 100 means the time period from the startup time point of the rotary machine 100 to the time point at which the working fluid having a predetermined temperature (for example, −70° C.) starts to be generated.

The rotary machine 100 further includes an electric motor 50 disposed coaxially with the rotary shaft 20. The electric motor 50 serves to rotate the rotary shaft 20. The electric motor 50 includes a rotor 51 and a stator 52. The rotor 51 is fixed to the rotary shaft 20. The stator 52 is fixed to the motor housing 60. The electric motor 50 may be used as an electric generator.

The electric motor 50 is disposed in the space 11 that the second end face 10b of the bearing 10 faces. According to such a structure, it is possible to suppress the heat transfer especially from the electric motor 50 to the working fluid by the first cavity 40. In the present embodiment, the space 11 is a motor space in which the electric motor 50 is disposed. Accordingly, the first cavity 40 is positioned between the back surface of the turbine wheel 30 and the motor space.

The bearing 10 is provided so as to protrude from the end face of the motor housing 60 in a direction toward the turbine housing 61. According to such a structure, it is easy to leave a space for the first cavity 40 to define the turbine housing 61.

The rotary machine 100 further includes a cooling jacket 53 disposed around the electric motor 50. The cooling jacket 53 is an example of the cooling structure for the rotary machine 100. In the present embodiment, the cooling jacket 53 is an annular flow path inside the motor housing 60. To the motor housing 60, an introduction flow path 54a and a discharge flow path 54b that each communicate with the cooling jacket 53 are attached. The introduction flow path 54a is a flow path for introducing the cooling fluid into the cooling jacket 53. The discharge flow path 54b is a flow path for discharging the cooling fluid from the cooling jacket 53. The electric motor 50 is cooled by causing the cooling fluid to flow through the cooling jacket 53. The cooling fluid may be a gas such as air or a liquid such as water, a brine, or an oil. The introduction flow path 54a and the discharge flow path 54b are each constituted of at least one pipe. In at least one of the introduction flow path 54a and the discharge flow path 54b, a valve 55 is disposed. The valve 55 may be an on-off valve or a flow control valve.

The rotary machine 100 further includes a turbine diffuser 62. The turbine diffuser 62 is a tubular part and is disposed downstream of the turbine wheel 30. The turbine diffuser 62 is attached to the turbine housing 61 so as to open toward the turbine wheel 30. The turbine wheel 30 and the turbine diffuser 62 are positioned so as to be coaxial with each other. The inner diameter of the turbine diffuser 62 gradually increases along the axial direction. The turbine diffuser 62 may be constituted of a portion of the turbine housing 61.

[1-2. Operation]

Next, an example of the operation of the rotary machine 100 will be described.

The working fluid flows into the volute 61h through the suction port (not shown) provided in the turbine housing 61, and further flows into the turbine nozzle 31 from the outer circumference of the turbine nozzle 31. The working fluid expands in the turbine nozzle 31, and accordingly its pressure is converted into the flow velocity. Thereafter, the working fluid is blown against the turbine wheel 30. An impulse is applied to the turbine wheel 30 by the blown working fluid. Depending on the state of the working fluid, the pressure is converted into the flow velocity again when the working fluid is discharged from the turbine wheel 30, so that the turbine wheel 30 receives a reaction from the working fluid. The rotary shaft 20 rotates by the impulse and reaction, and thus work is extracted from the working fluid. The working fluid discharged from the turbine wheel 30 flows into the turbine diffuser 62. The working fluid decelerates while flowing in the axial direction of the turbine diffuser 62 so as to be away from the turbine wheel 30, recovering its pressure. Thereafter, the working fluid is discharged to the outside of the rotary machine 100.

The above operation continuously decreases the temperature and pressure of the working fluid. In an expansion turbine having a pressure ratio of approximately 2 to 3, in the case where the temperature of the working fluid in the turbine nozzle 31 is 20° C., the temperature of the working fluid at an outlet 62a of the turbine diffuser 62 reaches approximately −20° C. to −40° C. Since the turbine housing 61, the turbine wheel 30, and the turbine nozzle 31 are in contact with the working fluid during or after the expansion process, these parts are low in temperature. On the other hand, since heat is generated by friction or electromagnetic loss, the heat generation sources such as the bearing 10, the rotary shaft 20, and the electric motor 50 are high in temperature. Consequently, a large temperature difference tends to occur between these heat generation sources and the working fluid. When a temperature difference occurs, heat is transferred from the heat generation sources to the working fluid through the turbine housing 61 and the turbine nozzle 31.

The first cavity 40 generates thermal resistance between the turbine nozzle 31 and the heat generation source such as the bearing 10. Owing to the action of the first cavity 40, the heat transfer from the heat generation source to the working fluid is suppressed.

[1-3. Effects Etc.]

As described above, in the present embodiment, the rotary machine 100 includes the first cavity 40. The first cavity 40 is present in the zone overlapping with the turbine nozzle 31 in the radial direction of the rotary shaft 20. In other words, the first cavity 40 is present in the zone overlapping with the turbine nozzle 31 as viewed along the axial direction of the rotary shaft 20. The first cavity 40 can generate thermal resistance between the turbine nozzle 31 and the heat generation source such as the bearing 10. Consequently, it is possible to suppress the heat transfer from the heat generation source such as the bearing 10 to the working fluid that is passing through the turbine nozzle 31. As a result, an unintended increase in temperature of the working fluid for the rotary machine 100 can be suppressed. The working fluid expands mainly in the turbine nozzle 31. While passing through the turbine nozzle 31, the working fluid is greatly decreased in temperature. Consequently, by suppressing the heat transfer from the heat generation source to the turbine nozzle 31, it is possible to suppress the heat transfer from the heat generation source to the working fluid and thus to decrease the temperature of the working fluid to a lower temperature.

Furthermore, in the present embodiment, the position at which the distance to the central axis O of the rotary shaft 20 in the radial direction is 1.0 times the radius of the turbine wheel 30 is defined as the first position. The position at which the distance to the central axis O of the rotary shaft 20 in the radial direction is 1.8 times the radius of the turbine wheel 30 is defined as the second position. The position at which the distance to the central axis O of the rotary shaft 20 in the radial direction is 1.1 times the radius of the turbine wheel 30 is defined as the third position. The first cavity 40 is present in the zone A from the first position to the second position in the radial direction. The turbine nozzle 31 is usually disposed in the zone from the third position to the second position in the radial direction. Consequently, owing to the presence of the first cavity 40 in the zone A, it is possible to more effectively suppress the heat transfer from the heat generation source such as the bearing 10 to the working fluid that is passing through the turbine nozzle 31.

Furthermore, in the present embodiment, the first cavity 40 is defined by the turbine housing 61. According to such a structure, it is possible to generate thermal resistance between the turbine nozzle 31 and the heat generation source such as the bearing 10 via the turbine housing 61. Furthermore, it is possible to shorten the startup time period of the rotary machine 100. The startup time period of the rotary machine 100 means the time period from the startup time point of the rotary machine 100 to the time point at which the working fluid having a predetermined temperature (for example, −70° C.) starts to be generated.

Furthermore, in the present embodiment, the electric motor 50 is disposed in the space 11 that the second end face 10b of the bearing 10 faces. According to such a structure, it is possible to suppress the heat transfer especially from the electric motor 50 to the working fluid by the first cavity 40.

Some other embodiments will be described below. The elements common to Embodiment 1 and the other embodiments are denoted by the same reference numerals, and the descriptions thereof may be omitted. The descriptions on the embodiments can be applied to each other unless they are technically contradictory. The embodiments may be combined with each other unless they are technically contradictory.

### Embodiment 2

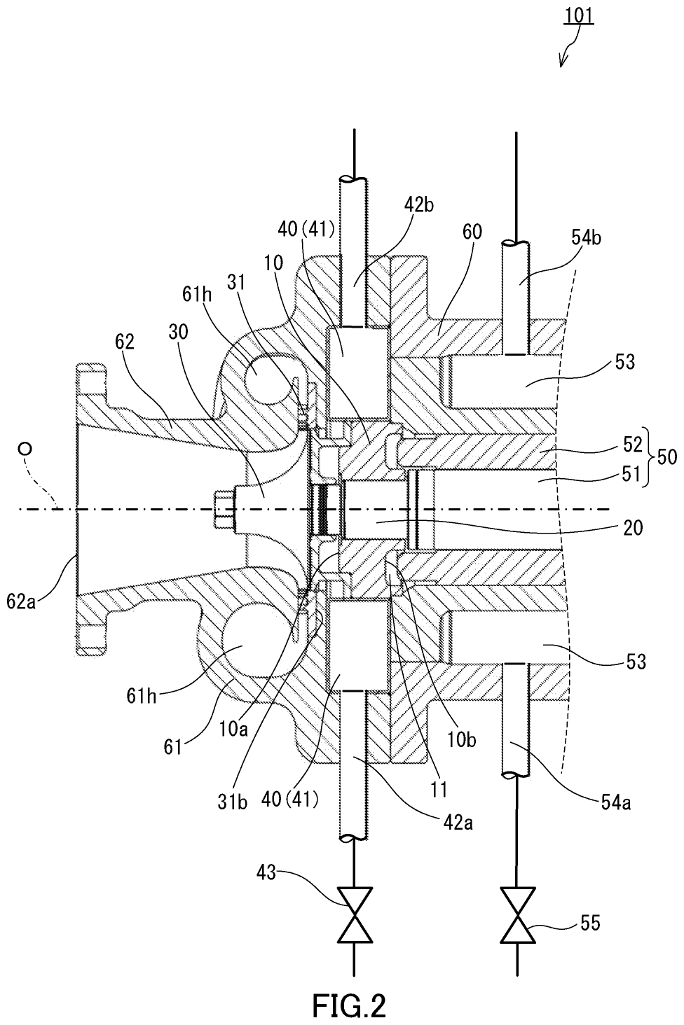

Embodiment 2 will be described below with reference to FIG. 2. In a rotary machine 101 of the present embodiment, the first cavity 40 functions as the flow path through which the cooling fluid flows. For this reason, in the present embodiment, the first cavity 40 is referred to also as a “first flow path 41”. The entire first cavity 40 may be the first flow path 41, or only a portion of the first cavity 40 may be the first flow path 41. The rotary machine 101 has the same structure as the rotary machine 100 of Embodiment 1, except that the first cavity 40 functions as the flow path.

[2-1. Configuration]

The first flow path 41 communicates with the flow path (not shown) through which the working fluid that is to flow into the turbine nozzle 31 flows. That is, a portion of the working fluid is used as the cooling fluid. The heat generation source such as the bearing 10 can be cooled by the working fluid that is to flow into the turbine nozzle 31. Consequently, it is possible to more effectively suppress the heat transfer from the heat generation source such as the bearing 10 to the working fluid that is passing through the turbine nozzle 31.

The rotary machine 101 further includes a valve 43 configured to change the flow rate of the working fluid in the first flow path 41. The valve 43 can change the flow rate of the working fluid in the first flow path 41 depending on the operating state of the rotary machine 101. For example, in the case where a sufficient effect is obtained only by the thermal resistance in the first flow path 41, the introduction of the working fluid into the first flow path 41 is suspended. This eliminates the need for the power for pumping the working fluid, thereby improving the efficiency of the rotary machine 101. The valve 43 may be an on-off valve or a flow control valve. In the case where the valve 43 is a flow control valve, the flow rate of the working fluid in the first flow path 41 can be adjusted in multiple stages by changing the opening degree of the valve 43.

The rotary machine 101 further includes an introduction flow path 42a and a discharge flow path 42b that each communicate with the first flow path 41. The introduction flow path 42a and the discharge flow path 42b are attached to the turbine housing 61. The introduction flow path 42a is a flow path for introducing the working fluid into the first flow path 41. The discharge flow path 42b is a flow path for discharging the working fluid from the first flow path 41. The heat generation source such as the bearing 10 is cooled by causing the working fluid to flow through the first flow path 41. The introduction flow path 42a and the discharge flow path 42b are each constituted of at least one pipe. In at least one of the introduction flow path 42a and the discharge flow path 42b, the valve 43 is disposed.

[2-2. Operation]

According to the rotary machine 101, a portion of the working fluid before expansion is directed to the first flow path 41. At this time, the heat generation source such as the bearing 10 is cooled by the working fluid. The working fluid directed from the introduction flow path 42a to the first flow path 41, flows into the discharge flow path 42b through the first flow path 41 while filling the entire first flow path 41, and is discharged to the outside from the discharge flow path 42b.

[2-3. Effects Etc.]

As described above, in the present embodiment, the first cavity 40 includes the first flow path 41. The first flow path 41 communicates with the flow path (not shown) through which the working fluid that is to flow into the turbine nozzle 31 flows. That is, a portion of the working fluid is used as the cooling fluid. The heat generation source such as the bearing 10 can be cooled by the working fluid that is to flow into the turbine nozzle 31. Consequently, it is possible to more effectively suppress the heat transfer from the heat generation source such as the bearing 10 to the working fluid that is passing through the turbine nozzle 31.

Furthermore, in the present embodiment, the rotary machine 101 further includes the valve 43 configured to change the flow rate of the working fluid in the first flow path 41. The valve 43 can change the flow rate of the working fluid in the first flow path 41 depending on the operating state of the rotary machine 101. For example, in the case where a sufficient effect is obtained only by the thermal resistance in the first flow path 41, the introduction of the working fluid into the first flow path 41 is suspended. This eliminates the need for the power for pumping the working fluid, thereby improving the efficiency of the rotary machine 101.

The rotary machine 101 is suitable for a refrigeration device in which air is used as the working fluid (refrigerant). This is because the working fluid discharged from the first flow path 41 can be directly released into the atmosphere. The introduction of air as the working fluid into the first flow path 41 and the automatic replenishment of the circuit of the refrigeration device with air from the atmosphere occur in parallel. No operation of replenishing with the working fluid is required at all.

In the present embodiment, the working fluid is used as the cooling fluid to be directed from the introduction flow path 42a to the first flow path 41. Alternatively, a cooling fluid other than the working fluid may be used. Furthermore, the type of the cooling fluid to be introduced into the first flow path 41 may be different from the type of the cooling fluid for the electric motor 50. The cooling fluid to be introduced into the first flow path 41 may be a gas such as air or a liquid such as water, a brine, or an oil.

### Embodiment 3

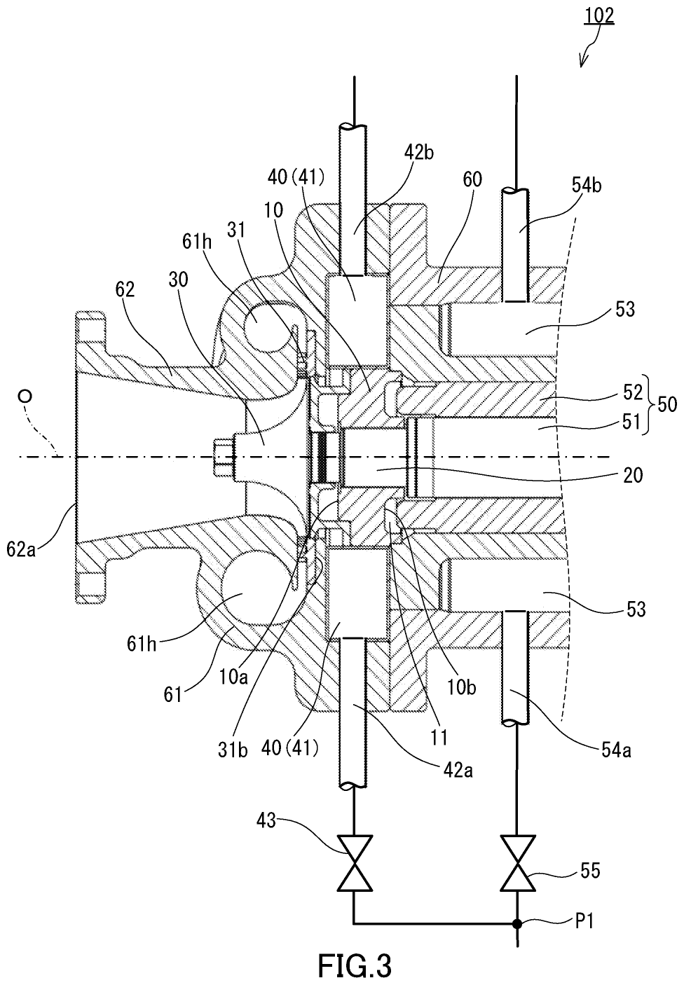

Embodiment 3 will be described below with reference to FIG. 3. A rotary machine 102 of the present embodiment has the same structure as the rotary machine 101 of Embodiment 2, except that a cooling fluid other than the working fluid for the rotary machine 102 flows through the first flow path 41.

[3-1. Configuration]

In the rotary machine 102, the cooling fluid other than the working fluid for the rotary machine 102 flows through the first flow path 41. According to such a structure, it is possible to cool the heat generation source such as the bearing 10 without reducing the cold output of the rotary machine 102, which is an expansion turbine. Consequently, it is possible to more effectively suppress the heat transfer from the heat generation source such as the bearing 10 to the working fluid that is passing through the turbine nozzle 31. Furthermore, since the working fluid for the rotary machine 102 is not used for cooling, it is possible to maintain the cold output even under changed operating conditions of the rotary machine 102.

In the rotary machine 102, the valve 43 can change the flow rate of the cooling fluid in the first flow path 41 depending on the operating state of the rotary machine 102.

In the present embodiment, the first flow path 41 communicates with the cooling jacket 53. According to such a structure, it is possible to cause the cooling fluid for the electric motor 50, which is a heat generation source, to flow through the first flow path 41. Furthermore, since the cooling fluid other than the working fluid is used, the power for pumping the working fluid is reduced, thereby improving the efficiency of the rotary machine 102.

In the present embodiment, the introduction flow path 42a branches from the introduction flow path 54a at a branch point P1. Consequently, the first flow path 41 indirectly communicates with the cooling jacket 53. The discharge flow path 42b joins the discharge flow path 54b at the junction (not shown in FIG. 3). That is, the first flow path 41 and the cooling jacket 53 are connected in parallel. Alternatively, the first flow path 41 and the cooling jacket 53 may be connected in series. For example, the introduction flow path 42a, the first flow path 41, the discharge flow path 42b, the introduction flow path 54a, the cooling jacket 53, and the discharge flow path 54b may be connected to each other so that the cooling fluid flows through these in this order. Alternatively, the introduction flow path 54a, the cooling jacket 53, the discharge flow path 54b, the introduction flow path 42a, the first flow path 41, and the discharge flow path 42b may be connected to each other so that the cooling fluid flows through these in this order. The cooling fluid flows through the first flow path 41 and the cooling jacket 53 in this order or in the reverse order. In the case where the cooling fluid other than the working fluid is air, air flowed through the first flow path 41 may be discharged to the external atmosphere through the discharge flow path 42b.

The valve 43 and the valve 55 are each disposed downstream from the branch point P1. At the branch point P1, a distribution valve may be provided together with or instead of the valve 43 and the valve 55.

The cooling fluid to be introduced into the first flow path 41 and the cooling jacket 53 may be a gas such as air or a liquid such as water, a brine, or an oil.

[3-2. Operation]

According to the rotary machine 102, the cooling fluid other than the working fluid for the rotary machine 102 is directed to the first flow path 41. At this time, the heat generation source such as the bearing 10 is cooled by the cooling fluid other than the working fluid. The cooling fluid other than the working fluid is distributed at the branch point P1 and thus travels to the introduction flow path 42a and the introduction flow path 54a. The cooling fluid directed from the introduction flow path 42a to the first flow path 41 flows into the discharge flow path 42b through the first flow path 41 while filling the entire first flow path 41, and is discharged to the outside from the discharge flow path 42b. The cooling fluid directed from the introduction flow path 54a to the cooling jacket 53 flows into the discharge flow path 54b through the cooling jacket 53 while filling the entire cooling jacket 53, and is discharged to the outside from the discharge flow path 54b. The discharge flow path 42b and the discharge flow path 54b may join together at the junction (not shown in FIG. 3).

[3-3. Effects Etc.]

As described above, in the present embodiment, the cooling fluid other than the working fluid for the rotary machine 102 flows through the first flow path 41. According to such a structure, it is possible to cool the heat generation source such as the bearing 10 without reducing the cold output of the rotary machine 102, which is an expansion turbine. Consequently, it is possible to more effectively suppress the heat transfer from the heat generation source such as the bearing 10 to the working fluid that is passing through the turbine nozzle 31.

Furthermore, in the rotary machine 102 of the present embodiment, the valve 43 can change the flow rate of the cooling fluid in the first flow path 41 depending on the operating state of the rotary machine 102.

Furthermore, in the present embodiment, the first flow path 41 communicates with the cooling jacket 53. According to such a structure, it is possible to cause the cooling fluid for the electric motor 50, which is a heat generation source, to flow through the first flow path 41. Furthermore, since the cooling fluid other than the working fluid is used, the power for pumping the working fluid is reduced, thereby improving the efficiency of the rotary machine 102.

### Embodiment 4

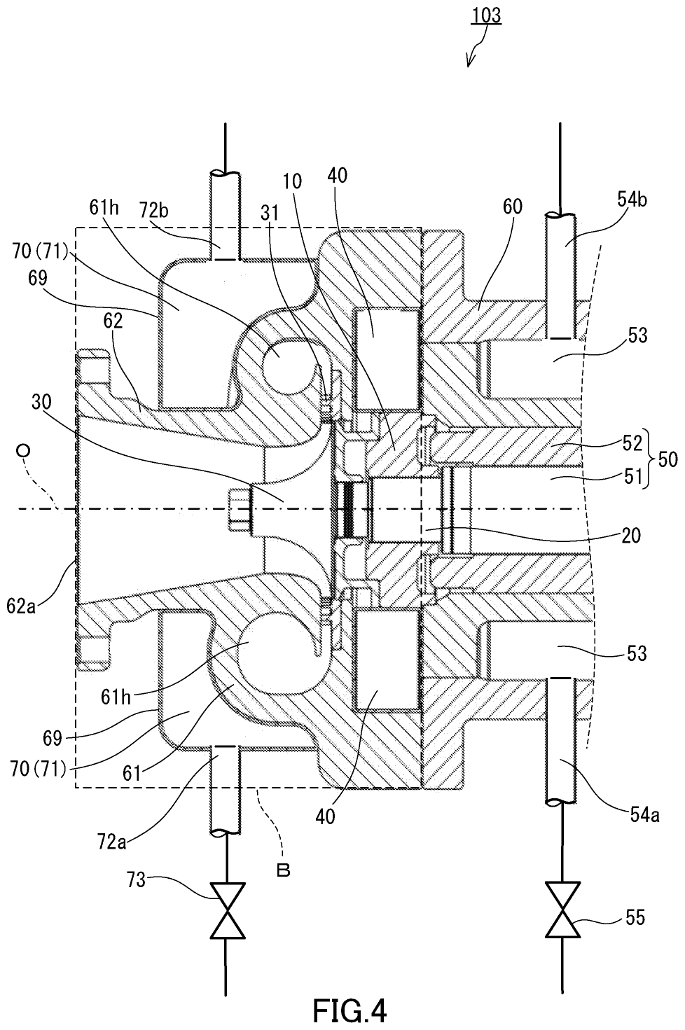

Embodiment 4 will be described below with reference to FIG. 4. A rotary machine 103 of the present embodiment has the same structure as any of the rotary machines 100 to 102 of the respective Embodiments 1 to 3, except that the rotary machine 103 includes a cover 69 and a second cavity 70.

[4-1. Configuration]

The cover 69 covers, at a position close to the outlet of the rotary machine 103, the outer peripheral surface of the turbine housing 61. The second cavity 70 is positioned between the cover 69 and the turbine housing 61. The second cavity 70 suppresses the heat transfer from the external atmosphere to the working fluid that is passing through the turbine nozzle 31. As a result, an unintended increase in temperature of the working fluid for the rotary machine 103 can be suppressed. The second cavity 70 can maintain the cold output even under changed operating conditions of the rotary machine 103.

The second cavity 70 is, for example, an annular space surrounding the turbine housing 61 along the circumferential direction of the rotary shaft 20. The second cavity 70 may be a C-shaped space, or may be a plurality of separate portions so as to surround the turbine housing 61. According to such a structure, it is possible to more uniformly suppress the heat transfer from the external atmosphere to the working fluid that is passing through the turbine nozzle 31.

The dimensions of the cover 69 are adjusted so as not to increase the substantial dimensions of the rotary machine 103. Specifically, the cover 69 fits within the zone of a circular column B having the minimum volume surrounding the turbine housing 61 and the turbine diffuser 62. The cover 69 is positioned between an open end 62a of the turbine diffuser 62 and the bearing 10 in the axial direction. The cover 69 may have a smaller diameter than the turbine housing 61 has. According to such a structure, in a refrigeration device including the rotary machine 103, it is easy to avoid an interference between the rotary machine 103 and other machines or parts.

In the rotary machine 103, the second cavity 70 functions as a flow path through which the cooling fluid flows. For this reason, in the present embodiment, the second cavity 70 is referred to also as a “second flow path 71”. The entire second cavity 70 may be the second flow path 71, or only a portion of the second cavity 70 may be the second flow path 71.

The second flow path 71 may communicate with the flow path (not shown) through which the working fluid that is to flow into the turbine nozzle 31 flows. That is, a portion of the working fluid may be used as the cooling fluid. The turbine housing 61 can be cooled by the working fluid that is to flow into the turbine nozzle 31. Specifically, the heat that has bypassed the first cavity 40 and reached the portion around the volute 61h and the turbine diffuser 62 can be discharged.

The rotary machine 103 further includes a valve 73 configured to change the flow rate of the working fluid in the second flow path 71. The valve 73 can change the flow rate of the working fluid in the second flow path 71 depending on the operating state of the rotary machine 103. For example, in the case where a sufficient effect is obtained only by the thermal resistance in the second flow path 71, the introduction of the working fluid into the second flow path 71 is suspended. This eliminates the need for the power for pumping the working fluid, thereby improving the efficiency of the rotary machine 103. The valve 73 may be an on-off valve or a flow control valve. In the case where the valve 73 is a flow control valve, the flow rate of the working fluid in the second flow path 71 can be adjusted in multiple stages by changing the opening degree of the valve 73.

The rotary machine 103 further includes an introduction flow path 72a and a discharge flow path 72b that each communicate with the second flow path 71. The introduction flow path 72a and the discharge flow path 72b are attached to the cover 69. The introduction flow path 72a is a flow path for introducing a portion of the working fluid into the second flow path 71. The discharge flow path 72b is a flow path for discharging a portion of the working fluid from the second flow path 71. The turbine housing 61 is cooled by causing a portion of the working fluid to flow into the second flow path 71. The introduction flow path 72a and the discharge flow path 72b are each constituted of at least one pipe. In at least one of the introduction flow path 72a and the discharge flow path 72b, the valve 73 is disposed. In the case where the working fluid is air, air flowed through the second flow path 71 may be discharged to the external atmosphere through the discharge flow path 72b.

In the rotary machine 103, a cooling fluid other than the working fluid for the rotary machine 103 may flow through the second flow path 71. According to such a structure, it is possible to cool the turbine housing 61 without reducing the cold output of the rotary machine 103, which is an expansion turbine. Furthermore, since the working fluid for the rotary machine 103 is not used for cooling, it is possible to maintain the cold output even under changed operating conditions of the rotary machine 103.

The second flow path 71 may communicate with the cooling jacket 53. According to such a structure, it is possible to cause the cooling fluid for the electric motor 50, which is a heat generation source, to flow through the second flow path 71. Furthermore, since the cooling fluid other than the working fluid is used, the power for pumping the working fluid is reduced, thereby improving the efficiency of the rotary machine 103.

The introduction flow path 72a may branch from the introduction flow path 54a at the branch point (not shown in FIG. 4). In this case, the second flow path 71 indirectly communicates with the cooling jacket 53. The discharge flow path 72b may join the discharge flow path 54b at the junction (not shown in FIG. 4). That is, the second flow path 71 and the cooling jacket 53 may be connected in parallel. Alternatively, the second flow path 71 and the cooling jacket 53 may be connected in series. For example, the introduction flow path 72a, the second flow path 71, the discharge flow path 72b, the introduction flow path 54a, the cooling jacket 53, and the discharge flow path 54b may be connected to each other so that the cooling fluid flows through these in this order. Alternatively, the introduction flow path 54a, the cooling jacket 53, the discharge flow path 54b, the introduction flow path 72a, the second flow path 71, and the discharge flow path 72b may be connected to each other so that the cooling fluid flows through these in this order. The cooling fluid flows through the second flow path 71 and the cooling jacket 53 in this order or in the reverse order. In the case where the cooling fluid other than the working fluid is air, air flowed through the second flow path 71 may be discharged to the external atmosphere through the discharge flow path 72b.

The valve 73 and the valve 55 each may be disposed downstream from the branch point between the introduction flow path 54a and the introduction flow path 72a. At the branch point, a distribution valve may be provided together with or instead of the valve 73 and the valve 55.

The first cavity 40 may be the first flow path 41. In this case, both the first flow path 41 and the second flow path 71 communicate with the cooling jacket 53. The working fluid that is to flow into the turbine nozzle 31 or other cooling fluid may be introduced into both the first flow path 41 and the second flow path 71 through the introduction flow path 42a (not shown in FIG. 4) and the introduction flow path 72a, respectively. In the latter case, the cooling fluid may flow through the first flow path 41, the second flow path 71, and the cooling jacket 53 in any order.

In the case where the second flow path 71 does not communicate with the cooling jacket 53, the type of the cooling fluid to be introduced into the second flow path 71 may be different from the type of cooling fluid for the electric motor 50. The cooling fluid to be introduced into the second flow path 71 may be a gas such as air or a liquid such as water, a brine, or an oil.

The second cavity 70 may be a closed space with no introduction of the working fluid. In this case, the second cavity 70 suppresses the heat transfer from the external atmosphere in which the rotary machine 103 is placed to the working fluid. In the case where the second cavity 70 is a closed space, the second cavity 70 may store a gas such as air or a liquid such as water, a brine, or an oil.

[4-2. Operation]

According to the rotary machine 103, the second cavity 70 suppresses the heat transfer from the external atmosphere to the working fluid that is passing through the turbine nozzle 31.

A portion of the working fluid before expansion may be directed to the second flow path 71. At this time, the turbine housing 61 is cooled by the working fluid. The working fluid directed from the introduction flow path 72a to the second flow path 71 flows into the discharge flow path 72b through the second flow path 71 while filling the entire second flow path 71, and is discharged to the outside from the discharge flow path 72b. The cooling fluid directed from the introduction flow path 54a to the cooling jacket 53 flows into the discharge flow path 54b through the cooling jacket 53 while filling the entire cooling jacket 53, and is discharged to the outside from the discharge flow path 54b. In the case where the same working fluid before expansion as the cooling fluid to be directed to the second flow path 71 is used as the cooling fluid that is to flow from the introduction flow path 54a into the cooling jacket 53, the working fluid as the cooling fluid may be distributed at a branch point (not shown in FIG. 4) and thus travel to the introduction flow path 72a and the introduction flow path 54a.

The cooling fluid other than the working fluid for the rotary machine 103 may be directed to the second flow path 71. At this time, the turbine housing 61 is cooled by the cooling fluid other than the working fluid. The cooling fluid other than the working fluid flows in a manner similar to that of the working fluid for the case where a portion of the working fluid before expansion is directed to the second flow path 71.

[4-3. Effects Etc.]

As described above, in the present embodiment, the second cavity 70 is positioned between the cover 69 and the turbine housing 61. The second cavity 70 suppresses the heat transfer from the external atmosphere to the working fluid that is passing through the turbine nozzle 31. As a result, an unintended increase in temperature of the working fluid for the rotary machine 103 can be suppressed. The second cavity 70 can maintain the cold output even under changed operating conditions of the rotary machine 103.

### Embodiment 5

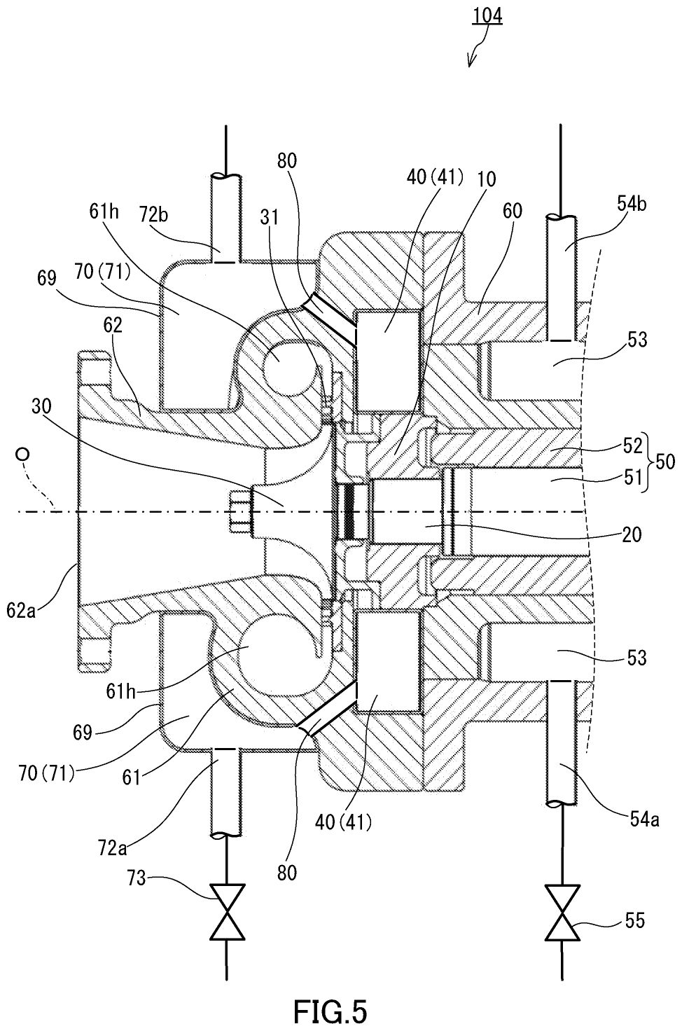

Embodiment 5 will be described below with reference to FIG. 5. A rotary machine 104 of the present embodiment has the same structure as the rotary machine 103 of Embodiment 4, except that the rotary machine 104 further includes a communication hole 80 via which the first cavity 40 and the second cavity 70 communicate with each other.

[5-1. Configuration]

The rotary machine 104 further includes the communication hole 80 via which the first cavity 40 and the second cavity 70 communicate with each other. According to such a structure, the cooling fluid can flow back and forth between the first cavity 40 and the second cavity 70 through the communication hole 80. As a result, it is possible to cool the rotary machine 104 more efficiently. In the case where the first cavity 40 (first flow path 41) is an annular space surrounding the bearing 10 along the circumferential direction of the rotary shaft 20 and the second cavity 70 (second flow path 71) is an annular space surrounding the turbine housing 61 along the circumferential direction of the rotary shaft 20, it is desirable that the rotary machine 104 should include the plurality of communication holes 80. Including the plurality of communication holes 80 facilitates the flowing of the cooling fluid through the first flow path 41 and the second flow path 71 and the back-and-forth flowing of the cooling fluid between the first cavity 40 and the second cavity 70 through the communication hole 80.

The capacity of the second cavity 70 may be larger than, smaller than, or equal to the capacity of the first cavity 40. The capacity of each of the cavities and the cross-sectional area of the communication hole 80 are determined so that the cooling fluid easily flows into the first flow path 41.

The communication hole 80 is provided in the turbine housing 61. Accordingly, the communication hole 80 does not increase the substantial dimensions of the rotary machine 104. According to such a structure, in a refrigeration device including the rotary machine 104, it is easy to avoid an interference between the rotary machine 104 and other machines or parts.

In the rotary machine 104, the first cavity 40 is the first flow path 41, and the second cavity 70 is the second flow path 71. The second flow path 71 may communicate with the flow path (not shown) through which the working fluid that is to flow into the turbine nozzle 31 flows. According to such a structure, it is possible to cool the rotary machine 104 efficiently by the working fluid that is to flow into the turbine nozzle 31.

In the rotary machine 104, a cooling fluid other than the working fluid for the rotary machine 104 may flow through the second flow path 71. According to such a structure, without reducing the cold output of the rotary machine 104, which is an expansion turbine, it is possible to cool the rotary machine 104 efficiently.

In the present embodiment, the rotary machine 104 does not include the introduction flow path 42a and the discharge flow path 42b (see FIG. 2), each of which communicates with the first flow path 41. Since such a structure is simpler, it is possible to suppress the manufacturing cost of the rotary machine 104. Instead of the introduction flow path 72a and the discharge flow path 72b, the introduction flow path 42a and the discharge flow path 42b, each of which communicates with the first flow path 41, may be provided. Furthermore, the set of the introduction flow path 42a, which communicates with the first flow path 41, and the discharge flow path 72b, which communicates with the second flow path 71, may be provided. Alternatively, the set of the introduction flow path 72a, which communicates with the second flow path 71, and the discharge flow path 42b, which communicates with the first flow path 41, may be provided.

[5-2. Operation]

According to the rotary machine 104, the cooling fluid can flow back and forth between the first flow path 41 and the second flow path 71 through the communication hole 80. The cooling fluid directed from the introduction flow path 72a to the second flow path 71 flows into the first flow path 41 through the second flow path 71 and the communication hole 80 while filling the entire second flow path 71. The cooling fluid, which has flowed into the first flow path 41, flows through the first flow path 41 while filling the entire first flow path 41, and is returned to the second flow path 71 through another communication hole 80. The cooling fluid flowed into the discharge flow path 72b is discharged to the outside from the discharge flow path 72b. In the case where the cooling fluid that is to flow through the second flow path 71 and the cooling fluid that is to flow through the cooling jacket 53 are the same type of cooling fluid, the cooling fluid may be distributed at the branch point (not shown) and thus travel to the introduction flow path 72a and the introduction flow path 54a. The discharge flow path 72b and the discharge flow path 54b may join together at the junction (not shown). In the case where the cooling fluid is air, air flowed through the second flow path 71 and the cooling jacket 53 may be discharged to the external atmosphere through the discharge flow path 72b and the discharge flow path 54b.

A portion of the working fluid before expansion may be directed to both the first flow path 41 and the second flow path 71. At this time, the rotary machine 104 is cooled by the working fluid.

The cooling fluid other than the working fluid for the rotary machine 104 may be directed to both the first flow path 41 and the second flow path 71. At this time, the rotary machine 104 is cooled by the cooling fluid other than the working fluid.

[5-3. Effects Etc.]

As described above, in the present embodiment, the rotary machine 104 further includes the communication hole 80 via which the first cavity 40 and the second cavity 70 communicate with each other. According to such a structure, the cooling fluid can flow back and forth between the first cavity 40 and the second cavity 70 through the communication hole 80. As a result, it is possible to cool the rotary machine 104 more efficiently.

### Embodiment 6

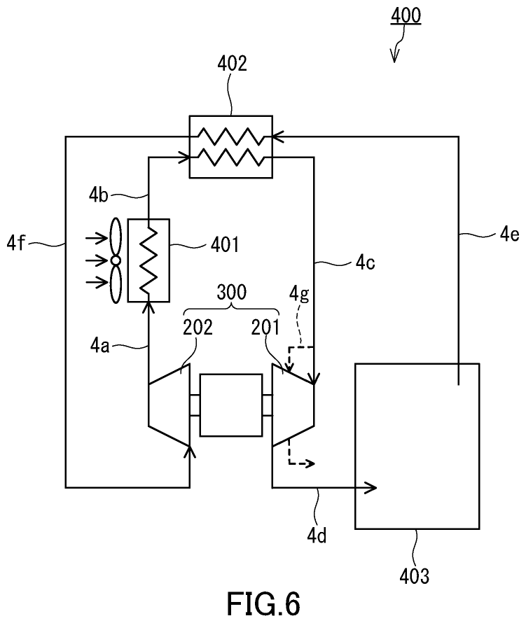

Embodiment 6 will be described below with reference to FIG. 6.

[6-1. Configuration]

FIG. 6 is a configuration diagram of a refrigeration device 400 according to Embodiment 6. The refrigeration device 400 includes a rotary machine 300, a first heat exchanger 401, and a second heat exchanger 402.

The rotary machine 300 includes an expansion mechanism 201 and a compression mechanism 202. The expansion mechanism 201 can be constituted of the rotary machine described in Embodiments 1 to 5.

The first heat exchanger 401 serves to cool the refrigerant by other fluid. The other fluid may be a gas or a liquid. The second heat exchanger 402 is an internal heat exchanger for recovering the cold of the refrigerant. Examples of the first heat exchanger 401 and the second heat exchanger 402 include a fin tube heat exchanger, a plate heat exchanger, a double-tube heat exchanger, and a shell-and-tube heat exchanger.

The thermal cycle of the refrigeration device 400 is an air refrigeration cycle in which air is used as the refrigerant. A low-temperature air generated by the refrigeration device 400 is directed to a target space 403. The target space 403 is, for example, a freezer. The refrigeration device 400 may be used for cabin air conditioning in aircraft. Since the global warming potential (GWP) of air is zero, it is desirable to use air as the refrigerant from the viewpoint of global environment protection. Furthermore, by using air as the refrigerant, the refrigeration device 400 can be constituted as an open system.

The rotary machine 300, the first heat exchanger 401, and the second heat exchanger 402 are connected to each other by flow paths 4a to 4f. The flow path 4a connects the discharge port of the compression mechanism 202 and the inlet of the first heat exchanger 401. The flow path 4b connects the refrigerant outlet of the first heat exchanger 401 and the high-pressure side inlet of the second heat exchanger 402. The flow path 4c connects the high-pressure side outlet of the second heat exchanger 402 and the suction port of the expansion mechanism 201. The flow path 4d connects the discharge port of the expansion mechanism 201 and the target space 403. The flow path 4e connects the target space 403 and the low-pressure side inlet of the second heat exchanger 402. The flow path 4f connects the low-pressure side outlet of the second heat exchanger 402 and the suction port of the compression mechanism 202. In the flow paths 4a to 4f, other equipment may be disposed such as another heat exchanger and a defroster.

The refrigerant compressed in the compression mechanism 202 is cooled in the first heat exchanger 401 and the second heat exchanger 402. The cooled refrigerant expands in the expansion mechanism 201. This further decreases the temperature of the refrigerant. The low-temperature refrigerant is supplied to the target space 403 for use for a desired purpose. The refrigerant discharged from the target space 403 is heated in the second heat exchanger 402, and then is introduced into the compression mechanism 202. In an example, the temperature of the refrigerant at the suction port of the compression mechanism 202 is 20° C. The temperature of the refrigerant at the discharge port of the compression mechanism 202 is 85° C. The temperature of the refrigerant at the refrigerant outlet of the first heat exchanger 401 is 40° C. The temperature of the refrigerant at the suction port of the expansion mechanism 201 is −30° C. The temperature of the refrigerant at the discharge port of the expansion mechanism 201 is −70° C.

The refrigeration device 400 may include a flow path 4g branched from the flow path 4c. For example, in the case where the rotary machine 101 described in Embodiment 2 is adopted as the expansion mechanism 201, a portion of the working fluid before expansion is introduced into the first flow path 41 through the flow path 4g.

[6-2. Effects Etc.]

The refrigeration device 400 of the present embodiment includes, as the expansion mechanism 201, any one of the rotary machines 100 to 104 respectively described in Embodiments 1 to 5. By adopting any one of the rotary machines 100 to 104, a lower-temperature refrigerant can be generated.

In the present embodiment, the refrigerant may be air. It is desirable to use air as the refrigerant from the viewpoint of global environment protection. Furthermore, by using air as the refrigerant, the refrigeration device 400 can be constituted as an open system.

According to the refrigeration device 400 of the present embodiment, the heat transfer from the parts of the expansion mechanism 201 to the refrigerant is suppressed in the rotary machine 300, and accordingly a lower-temperature refrigerant can be generated. Adopting the rotary machine 300 improves the coefficient of performance of the refrigeration device 400.

### Other Embodiments

As described above, Embodiments 1 to 6 have been described as an illustration of the technique disclosed in the present application. However, the technique according to the present disclosure is not limited to these, and can be applied also to embodiments obtained by making modifications, replacements, additions, omissions, and the like. Furthermore, the components described in Embodiments 1 to 6 above can be combined to obtain a new embodiment as well.

The technique of the present disclosure is applicable also to single-stage axial-flow expansion turbines. Furthermore, the technique of the present disclosure is applicable not only to expansion turbines but also to compressors. For example, in the case where a compressor that handles low-temperature working fluids cannot accept an increase in temperature of the working fluid, the technique of the present disclosure enables the temperature of the working fluid to be an appropriate temperature.

### INDUSTRIAL APPLICABILITY

The technique of the present disclosure is applicable to rotary machines such as expansion turbines, compressors, and prime movers for electric generation.

1. A rotary machine comprising:
a rotary shaft;
a turbine wheel attached to the rotary shaft;
a turbine nozzle disposed around the turbine wheel;
a bearing supporting the rotary shaft, and having a first end face and a second end face each positioned in an axial direction of the rotary shaft, where a distance from the first end face to the turbine wheel is shorter than a distance from the second end face to the turbine wheel; and
a first cavity positioned, in the axial direction of the rotary shaft, between a back surface of the turbine nozzle and the second end face of the bearing or between the back surface of the turbine nozzle and a space that the second end face of the bearing faces, the first cavity being present in a zone overlapping with the turbine nozzle in a radial direction of the rotary shaft.

2. The rotary machine according to claim 1, wherein
when a position at which a distance to a central axis of the rotary shaft in the radial direction of the rotary shaft is 1.0 times a radius of the turbine wheel is defined as a first position and a position at which the distance to the central axis of the rotary shaft in the radial direction of the rotary shaft is 1.8 times the radius of the turbine wheel is defined as a second position,
the first cavity is present in a zone from the first position to the second position in the radial direction of the rotary shaft.

3. The rotary machine according to claim 1, wherein
the first cavity comprises a first flow path, and
the first flow path communicates with a flow path through which a working fluid that is to flow into the turbine nozzle flows.

4. The rotary machine according to claim 1, wherein
the first cavity comprises a first flow path through which a cooling fluid other than a working fluid for the rotary machine flows.

5. The rotary machine according to claim 3 further comprising
a valve configured to change a flow rate of the working fluid in the first flow path.

6. The rotary machine according to claim 4 further comprising
a valve configured to change a flow rate of the cooling fluid in the first flow path.

7. The rotary machine according to claim 1 further comprising
a turbine housing surrounding the turbine wheel, wherein
the first cavity is defined by the turbine housing.

8. The rotary machine according to claim 7 further comprising:
a cover covering, at a position close to an outlet of the rotary machine, an outer peripheral surface of the turbine housing; and
a second cavity positioned between the cover and the turbine housing.

9. The rotary machine according to claim 8 further comprising
a communication hole via which the first cavity and the second cavity communicate with each other.

10. The rotary machine according to claim 1 further comprising
an electric motor disposed coaxially with the rotary shaft, wherein
the electric motor is disposed in the space that the second end face of the bearing faces.

11. The rotary machine according to claim 10 further comprising
a cooling jacket disposed around the electric motor, wherein
the first cavity and the cooling jacket communicate with each other.

12. A refrigeration device comprising the rotary machine according to claim 1.
